(19) United States
(12) Patent Application Publication
(10) Pub. No.: US 2025/0180725 A1
(43) Pub. Date: Jun. 5, 2025

(54) RADAR PULSE WITH LINEAR FREQUENCY MODULATION

(71) Applicant: COMMISSARIAT A L’ENERGIE ATOMIQUE ET AUX ENERGIES ALTERNATIVES, PARIS (FR)

(72) Inventors: Mykhailo ZARUDNIEV, GRENOBLE (FR); Laurent OUVRY, GRENOBLE (FR); Cédric DEHOS, GRENOBLE (FR); Pierre COUROUVE, GRENOBLE (FR)

(21) Appl. No.: 18/964,400

(22) Filed: Nov. 30, 2024

(30) Foreign Application Priority Data
Nov. 30, 2023 (FR) 2313339

(51) Int. Cl. G01S 13/22; G01S 7/28; G01S 7/282; G01S 7/288; G01S 13/02

(52) U.S. Cl. CPC G01S 13/22; G01S 7/2806; G01S 7/282; G01S 7/288; G01S 13/0209

(57) ABSTRACT

A device for generating a radar signal includes: a generator of periodically repeated series of trigger pulses having a linearly variable temporal spacing; and an oscillator configured to receive as input said trigger pulses and to generate a train of periodic oscillations in correspondence with each said trigger pulse. The oscillator has a frequency that varies as a function of a control signal. The device includes a generator of the control signal, suitable for varying linearly the frequency of the oscillator from one train of periodic oscillations to another. Furthermore, a radar device includes a transmit channel having such a device for generating a radar signal; and a receive channel configured to receive echoes of the radar signal and to demodulate them synchronously with their generation to extract time-of-flight information therefrom.

### CROSS-REFERENCE TO RELATED APPLICATION

This application claims priority to foreign French patent application No. FR 2313339, filed on Nov. 30, 2023, the disclosure of which is incorporated by reference in its entirety.

### FIELD OF THE INVENTION

The invention relates to the field of radars, and more particularly SoC radars (SoC standing for system-on-chip) that are in particular usable to measure vital signs of a patient or as a presence detector-see for example (Antide 2020). These radars must have both a high spatial resolution (of the order of a few centimeters) and a low power consumption (a few tens of mW).

### BACKGROUND

A technique commonly used in these applications is the FMCW-DC technique (FMCW-DC standing for frequency-modulated continuous-wave duty-cycled)-see for example (Liu 2019) and (Siligaris 2023). Specifically, this technique exploits the principle of compression of a wave transmitted with a wide bandwidth to a narrow intermediate-frequency bandwidth, this making it possible to use analog-to-digital converters (ADCs) having a relatively low acquisition rate, a few MSps or tens of MSps (1 MSps=10⁶ samples per second-MSps standing for mega samples per second). However, in the presence of targets having very diverse radar cross sections (RCSs), it would be necessary to use ADCs having a high dynamic range, for example 9 to 12 bits or more, and therefore a relatively high power consumption.

An alternative is to use the IR-UWB technique (IR-UWB standing for impulse-radio ultrawide-band), in which a short pulse is emitted and the time of flight of its echo is measured to determine the distance of the target. See for example (Andersen 2017). One advantage of this technique is that, as the echo signals are separated in time, it is possible to apply automatic gain control (AGC) to make possible acquisition of a highly contrasted environment in the presence of objects of very diverse RCSs while limiting the dynamic range of the ADCs. In contrast, obtaining a good spatial resolution depends on use of a high acquisition rate, of several GSps (1 GSps=10⁹ samples per second-GSps standing for giga samples per second).

### SUMMARY

The invention aims to overcome, in whole or in part, the aforementioned drawbacks of the prior art. More particularly, it aims to make it possible to use ADCs having a lower dynamic range than in FMCW-DC radars and a lower acquisition rate than in IR-UWB radars, without however sacrificing either spatial resolution, or dynamic range in respect of the RCSs of the targets detectable.

According to the invention, this aim is achieved by virtue of generation of a radar signal consisting of periodically repeated series of trains of periodic oscillations. The trains of oscillations of a given series have a linearly variable temporal spacing while, inside a series, the frequency of the oscillations varies linearly from one train of periodic oscillations to another. Since the radar signal is pulsed (specifically it consists of spaced-apart trains of periodic oscillations), the echo signals are separated in time, as in the case of the IR-UWB technique, allowing gain control, which permits use of ADCs of relatively low dynamic range even in the presence of a contrasted environment.

Furthermore, the combination of a variable spacing of the trains of oscillations and a modification of the frequency of the oscillations from one train to another allows—as will be demonstrated below-a compression of the bandwidth of the echoes, allowing the use of ADCs having a relatively low acquisition rate without sacrificing spatial resolution, as in the case of the FMCW-DC technique. This combination of variable spacing of the trains of oscillations and change of the frequency of the oscillations from one train to another is unknown from the prior art. Also, for example, in FR 3 116 613 the spacing of the trains of oscillations is variable, but not the frequency of the oscillations. Conversely, in FR 2 738 352, it is the frequency of the oscillations which varies, but the spacing between trains of oscillations is constant. Furthermore, the present inventors have discovered and demonstrated that the combination of a variable spacing of the trains of oscillations and a change of the frequency of the oscillations from one train to another allows, in an unexpected manner—as it will be demonstrated later-a compression of the bandwidth of echoes during their detection, authorizing the use of ADCs having a relatively low acquisition rate without sacrificing spatial resolution, as in the case of the technique FMCW-DC.

Thus, one subject of the invention is a device for generating a radar signal, comprising:
a generator of periodically repeated series of trigger pulses, the pulses of a given series having a linearly variable temporal spacing; and
an oscillator configured to receive as input said trigger pulses and to generate a train of periodic oscillations in correspondence with each said trigger pulse;
   wherein
said oscillator has a frequency that varies as a function of a control signal;
   and wherein
the device also comprises a generator of said control signal, which is suitable for varying linearly in time the frequency of the oscillator from one train of periodic oscillations to another for trains of periodic oscillations triggered by trigger pulses belonging to a given series.

Another subject of the invention is a radar device, comprising:
a transmit channel comprising a device for generating a radar signal such as described above; and
a receive channel configured to receive echoes of said radar signal and to demodulate them synchronously with their generation so as to extract time-of-flight information therefrom.

Yet another subject of the invention is a method for generating a radar signal comprising generating periodically repeated series of trains of periodic oscillations, the trains of oscillations of a given series having a linearly variable temporal spacing; the frequency of the oscillations varying linearly from one train of periodic oscillations to another in a given series.

### BRIEF DESCRIPTION OF THE DRAWINGS

Other features, details and advantages of the invention will become apparent on reading the description given with reference to the appended drawings, which are given by way of example, and which show, respectively:

FIG. 1, the functional schematic of a radar generating device according to one embodiment of the invention;

FIG. 2, the graph of a spectral template that the generated radar signals must respect;

FIG. 3, the spectrogram of the radar signal generated by the device of FIG. 1;

FIG. 4, the functional schematic of a radar device according to one embodiment of the invention;

FIG. 5A, the signal output from the mixer of the receive channel of the device of [FIG. 4], shown in the time domain, in the case of a single target located at a distance of 3.75 m (time of flight: 25 ns);

FIG. 5B, an enlargement of a segment of FIG. 5A;

FIG. 6A, the signal output from the mixer of the receive channel of the device of FIG. 4, shown in the spectral domain, also in the case of a single target located at a distance of 3.75 m (time of flight: 25 ns);

FIG. 6B, an enlargement of a segment of FIG. 6A;

FIG. 7A, FIG. 7B and FIG. 7C, the signals output from the receive channel of the mixer of the device of FIG. 4, from the low-pass filter and from a module for computing a Fourier transform, respectively, in the case of three targets located at 1 m, 5 m and 12 m;

FIG. 8, a functional schematic of a radar device according to another embodiment of the invention;

FIG. 9A, the signal under-sampled by the receive channel of the device of FIG. 8, also in the case of three targets located at 1 m, 5 m and 12 m;

FIG. 9B, an enlargement of a segment of FIG. 9A;

FIG. 10, the functional schematic of a radar device according to yet another embodiment of the invention; and

FIG. 11A, the signal under-sampled by the receive channel of the device of FIG. 10 in the case of three targets located at distances of 1 m, 5 m and 12 m, respectively;

FIG. 11B, an enlargement of a segment of FIG. 11A; and

FIG. 11C, the signal obtained via Fourier transform of the signal of FIG. 11A.

### DETAILED DESCRIPTION

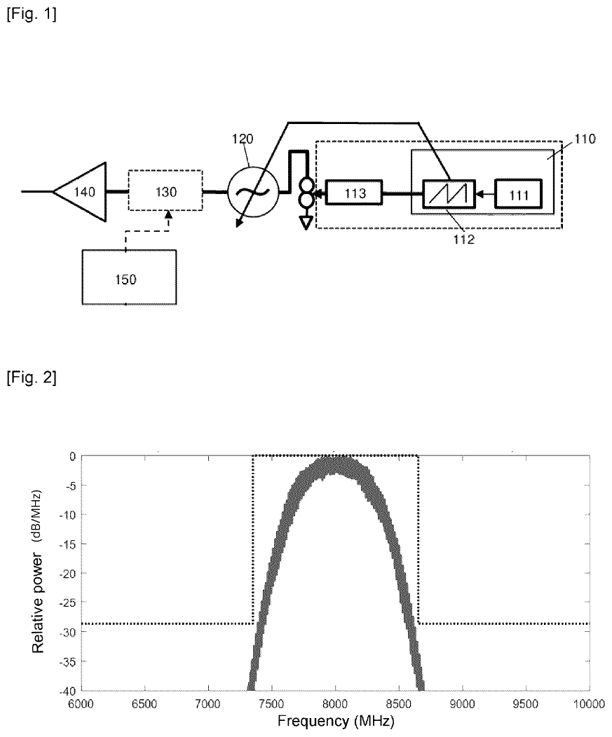

The device for generating a radar signal of FIG. 1 comprises a first generator of a first signal s_{c}(t) taking the form of a periodic sequence of trains of chirped oscillations:

$${s}_{c} = sin ( 2 π ( {f}_{PRF 0} t + \frac{{B}_{PRF}}{2 {T}_{chirp}} {τ}^{2} ) ) , ∀ t ∈ [ 0 ; {T}_{chirp} ) \qquad ( 1 )$$

where f_{pRF0} is the frequency of the oscillations of the first signal at the start of each train of chirped oscillations, B_{PRF}/T_{chirp} is the chirp rate of said oscillations, t is time and T_{chirp} is the repetition period of the trains of oscillations. It will be understood that a train starts with oscillations at the frequency f_{pRF0}, which frequency gradually increases to f_{PRF0}+B_{PRF}; B_{PRF} is therefore the bandwidth of the signal s_{PRF}. As a variant, the frequency may decrease gradually to f_{PRF0}−B_{PRF}. In both cases, the frequency of the oscillations returns to a value f_{pRF0} after the time T_{chirp} or indeed T_{chirp}+T_{guard} if a guard interval T_{guard} is required between two pulse trains.

The frequency f_{PRF0} is generally of the order of a few MHz, and for example between 1 and 100 MHz. In the following, f_{PRF0}=19.4 MHZ, B_{PRF}=1.2 MHZ (this giving an average pulse repetition frequency of 20 MHZ) and T_{chirp}=40 μs_{c}.

The first signal generator 112 may, for example, comprise a generator of sawtooth waveforms (voltage ramps) clocked by a clock 111 and driving a voltage-controlled oscillator (not shown).

The oscillatory signal s_{c} is used by a trigger pulse generator 113 to generate periodically repeated series of trigger pulses synchronously with the oscillations of said first signal. For example, a trigger pulse may be generated in correspondence with each oscillation, or with each zero crossing of the first signal (there are therefore two trigger pulses per oscillation), etc. Below, the case where a trigger pulse is generated each time an oscillation of the first signal starts will be considered, which may be achieved using a duty cycle controller. It is easy to work out that the series of pulses corresponding to each repetition of the train of oscillations of the first signal is given by

$${s}_{PRF} = {\sum }_{n = 1}^{{n}_{{max}_{=}}} {δ}_{{f}_{PRFmin} t + \frac{{B}_{PRF}}{2 {T}_{chirp}} {t}^{2} - {t}_{s} ( n )} , ∀ t ∈ [ 0 ; {T}_{chirp} ) \qquad ( 2 )$$

where the temporal positions tₛ(n) of each pulse are given by

$${t}_{s} ( n ) = \frac{{f}_{PRF 0} \cdot {T}_{chirp}}{{B}_{PRF}} ( - 1 + \sqrt{1 + \frac{2 {B}_{PRF}}{{f}_{PRF {0}^{2}} \cdot {T}_{chirp}} ( n - 1 )} ) , n ∈ \{ 1 , … , {n}_{max} \} \qquad ( 3 )$$

where Nₘₐₓ is the number of pulses in each series.

It will be noted that the spacing Δtₛ(n)=tₛ(n+1)−tₛ(n) between two pulses varies linearly (at least to a first approximation) over time.

In FIG. 1, block 110 designates the generator of periodically repeated series of trigger pulses s_{PRF} with variable spacing. This block comprises the clock 111, the first signal generator 112—which in turn consists, in the example considered here, of a voltage-ramp generator and a frequency-controlled oscillator—and the pulse generator 113. Those skilled in the art will be able to conceive of other architectures for implementing this functional block.

The trigger pulses s_{PRF} activate an oscillator 120 for a short time—of the order of magnitude of the duration of a pulse—this leading to generation of a train of periodic oscillations at an oscillator frequency f_{c} much higher than the frequency of the oscillations of the first signal. Typically, if the frequency of the oscillations of the first signal is of the order of a few tens of MHz, f_{c} will be of the order of a few GHz. The oscillator 120 therefore generates microwave pulses. The term “microwave” is understood to mean frequencies between 300 MHz and 300 GHz, but the oscillator 120 will preferably operate in the range 1 GHz to 100 GHz.

The waveform generated by the oscillator 120 activated/deactivated by a trigger pulse may have a spectrum incompatible with applicable regulations. For this reason, the trains of oscillations (which will also be called “microwave pulses” below) may be shaped by a shaper 130. A number of forms of microwave pulse envelopes are feasible, with a view to achieving compatibility with the regulations and spectral masks with which it is necessary to comply. Below, the case of Gaussian pulses the envelope of which is given by the following equation will be considered

$$A ( t ) = {e}^{- \frac{{( t - γ τ )}^{2}}{{τ}^{2}}} \qquad ( 4 )$$

where γ is a dimensionless parameter that sets its position relative to the corresponding trigger pulse (for example it is possible for γ=3) and τ is another parameter, having the dimensions of time, that sets the duration of the microwave pulse, and therefore its spectral width. If the target bandwidth of the microwave pulse is Bₚᵤₗₛₑ, the following is obtained

$$τ = \frac{\sqrt{- 2 \cdot ln ( {10}^{{log}_{10} - {x}_{dB}} )}}{π \cdot {B}_{p u l s e}} \qquad ( 5 )$$

where x_{dB} is the reference level (in dB) used to measure the bandwidth Bₚᵤₗₛₑ (in general, x_{dB} is equal to −3 dB or −10 dB).

The microwave oscillator 120 is a frequency-controlled generator driven by a control signal Vₜᵤₙₑ in such a way that the frequency f_{c} varies linearly in time over a period T_{chirp}, i.e. for microwave pulses corresponding to trigger pulses of a given series.

Advantageously, this control signal is generated by the first signal generator 112 so as to ensure synchronism between the variations in oscillation frequency of the oscillator 120 and the generation of the trigger pulses. In particular, the control signal Vₜᵤₙₑ may be a replica of the voltage ramps used in the generation of the first signal. As a variant, a separate control signal generator may be used.

Optionally, a phase scrambler 150 may interact with the pulse shaper to apply phase scrambling to the microwave pulses, this allowing their spectrum to be smoothed. A power amplifier 140 may also amplify the signal prior to its transmission.

The signal generated by the oscillator 120 may be written-excluding a multiplicative coefficient defining its amplitude, and neglecting any phase scrambling:

$${s}_{TX} ( t ) = {\sum }_{n = 1}^{nmax} {e}^{- \frac{{( t - γτ - {t}_{s} ( n ) )}^{2}}{{τ}^{2}}} \cdot sin ( 2 π {f}_{c} ( n ) \cdot ( t - {t}_{s} ( n ) ) ) \qquad ( 6 )$$

in which the dependence on the oscillator frequency f_{c} and on the number of pulses, and therefore on time, has been shown.

The oscillator 120 and its control signal Vₜᵤₙₑ are such that the frequency f_{c} varies linearly in time from one microwave pulse to another, while remaining constant during a given pulse. More particularly, the variation in the oscillation frequency f_{c} is advantageously chosen so that the power spectral density of a high-order harmonic k of the minimum repetition frequency f_{PRF0} of the trigger pulses remains constant over a spectral band defined by a template. This is illustrated in FIG. 2 in the case f_{PRF0}=20 MHz and K=400. In the figure, the dotted line represents a spectral template centred on 8 GHz and the solid line represents the spectrum of the harmonic k=400 (smoothed by virtue of phase scrambling to remove fast oscillations at 20 MHz, see infra). It will be understood that spectral efficiency will be maximum when the spectrum of the harmonic remains constant over the entire width of the template. For this reason, it is chosen to define the variation in the frequency of the oscillator 120 by the following law

$${f}_{c} ( n ) = K ( {f}_{PRF 0} + \frac{{B}_{PRF}}{{T}_{chirp}} {t}_{s} ( n ) ) \qquad ( 7 )$$

Alternatively, the condition of equation (7) can be relaxed and only require that the average value of f_{c} be a multiple of the average repetition frequency of the trigger pulses,

$$= {f}_{PRF 0} + \frac{{B}_{PRF}}{2} .$$

The spectrum S_{TX}(f) of the signal s_{TX}(t) given by (6) and (7) may be written

$${S}_{TX} ( f ) = \frac{\sqrt{π} τ}{2 j} {\sum }_{n = 1}^{nmax} ( {e}^{- {( π ( f + {f}_{c} ( n ) ) τ )}^{2}} - {e}^{- {( π ( f - {f}_{c} ( n ) ) τ )}^{2}} ) \cdot {e}^{- j 2 π f ( {t}_{s} ( n ) + γ τ )} \qquad ( 8 )$$

where “j” is the imaginary unit.

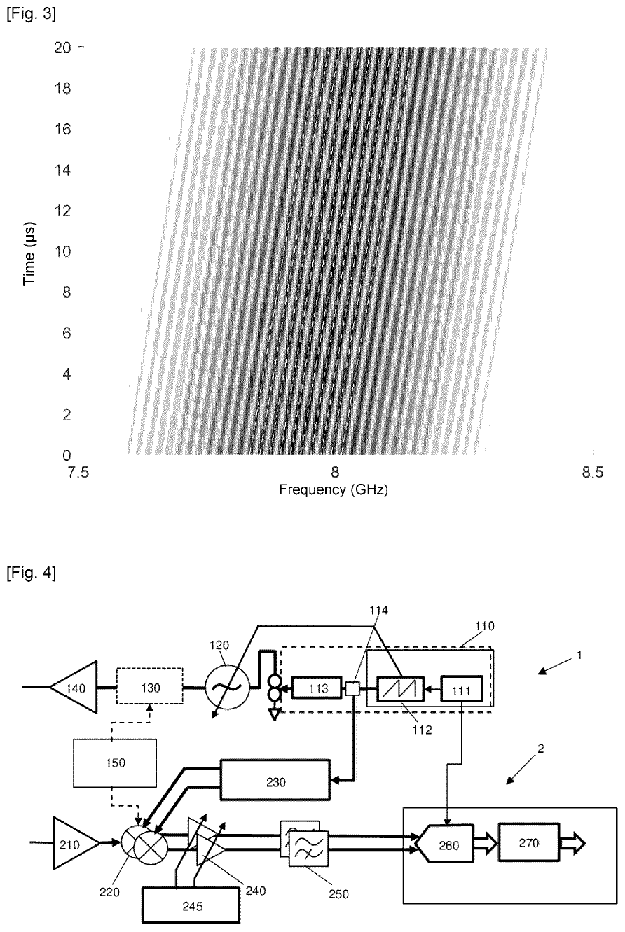

FIG. 3 is a spectrogram of the signal S_{TX}(t). The oblique dashed lines show modulated (“chirped”) discrete harmonics the frequency of which is given by

$$k ( {f}_{PRF 0} + \frac{{B}_{PRF}}{{T}_{chirp}} t ) .$$

The spectrum of equation (8) may be approximated by

$${s}_{TX} ( t ) \approx {\sum }_{k = 0}^{+ ∞} {c}_{k} ( t ) \cdot \frac{{e}^{j 2 π k} ( {f}_{PRF 0} t + \frac{{B}_{PRF}}{2 {T}_{chirp}} {t}^{2} ) - {e}^{- j 2 π k} ( {f}_{PRF 0} t + \frac{{B}_{PRF}}{2 {T}_{chirp}} {t}^{2} )}{2 \cdot j} \cdot Π ( \frac{f - {T}_{chirp} / 2}{{T}_{chirp}} ) \qquad ( 9 )$$

where Π is a gate function, which is equal to 1 inside the interval [−½, ½] and 0 outside. It is possible to verify that the coefficients cₖ(t) of the series vary relatively little over a duration T_{chirp}; it is therefore possible to replace them by their average values c̅ₖ̅ over said duration T_{chirp}. This therefore gives:

$${s}_{T X} ( t ) \approx = {\sum }_{k = 0}^{+ ∞} \overline{{c}_{k}} \cdot \frac{{e}^{j 2 π k ( {f}_{PRF 0} t + \frac{{B}_{P R F}}{2 {T}_{c hirp}} {t}^{2} )} - {e}^{- j 2 π k ( {f}_{PRF 0} t + \frac{{B}_{PRF}}{2 {T}_{chirp}} {t}^{2} )}}{2 \cdot j} \cdot Π ( \frac{t - \frac{{T}_{chirp}}{2}}{{T}_{chirp}} ) = {\sum }_{k = 0}^{+ ∞} \cdot sin ( 2 π k ( {f}_{PRF 0} t + \frac{{B}_{PRF}}{2 {T}_{chirp}} {t}^{2} ) ) , ∀ t ∈ [ 0 , {T}_{train} ) \qquad ( 10 )$$

Equation (10) shows that the generated radar signal may be written as a sum of chirped components about a multiple of the fundamental frequency f_{PRF0}. The component of highest amplitude corresponds to k=K. Using an oscillatory signal of relatively low frequency (the first signal) to generate trigger pulses for triggering a microwave oscillator allows a particularly low phase noise to be obtained, as demonstrated in (Siligaris 2023). Unlike the case of (Siligaris 2023), however, in the case of the invention the radar signal is pulsed and the frequency of the microwave carrier varies linearly from one pulse to another.

The signal s_{TX}(t) is intended to be transmitted by a radar antenna and reflected by one or more targets. The echo signals are then detected and demodulated with a view to extracting target distance information therefrom. Considering a single target at a distance D from the transmit and receive antennas (which are assumed to be coincident or collocated-case of monostatic radar, but generalization to the bistatic case poses no difficulty), the echo is received with a delay τ_{AR}=D/c, where c is the speed of light. The received signal is therefore written (excluding an amplitude-related multiplicative factor):

$$( t - {τ}_{A R} ) = {\sum }_{k = 0}^{+ ∞} \overline{{c}_{k}} \cdot \frac{{e}^{j 2 π {k ( {f}_{PRF 0} ( t - {τ}_{A R} ) + \frac{{B}_{PRF}}{2 {T}_{chirp}} {( t - {τ}_{AR} )}^{2} )}_{- c . c .}}}{2 \cdot j} , ∀ t ∈ [ {τ}_{AR} , {T}_{chirp} ) \qquad ( 11 )$$

where “c.c.” designates the conjugate complex and the gate function may be omitted given that time is defined only over an interval [τ_{AR}, T_{chirp}), i.e. between the start of receipt of the echo and the end of the transmit signal.

This received signal may be demodulated in a number of ways. Two will be considered below (and their combination):
coherent demodulation by means of a chirped local-oscillator signal;
non-uniform sampling.

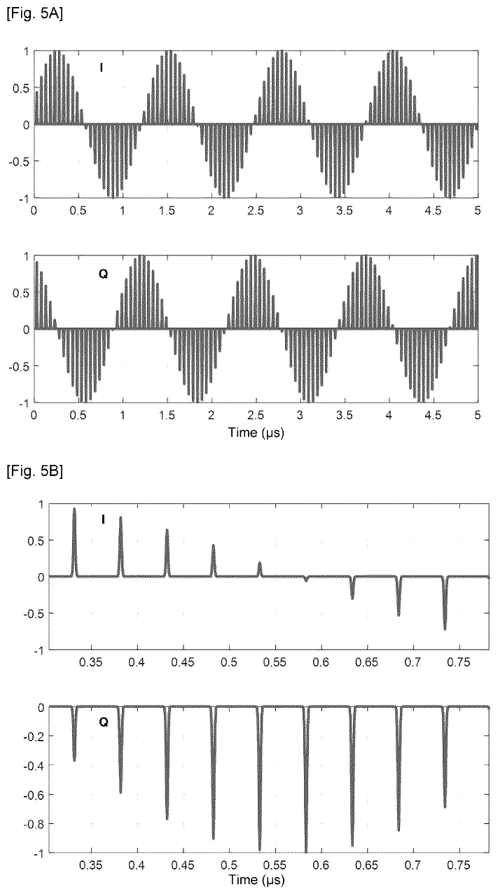

FIG. 4 shows the functional schematic of a radar device according to an embodiment of the invention comprising one transmit channel 1 and one receive channel 2. The transmit channel essentially consists of a device for generating a radar signal of the type shown in [FIG. 1]. The receive channel 2 carries out coherent demodulation of a received echo signal, as explained below.

The receive channel 2 comprises a low-noise amplifier 210 for pre-amplifying the received signal, followed by an I/Q mixer 220 for converting it to an intermediate frequency. The mixer also receives as input a local-oscillator signal s_{RX}, which it multiplies by the pre-amplified echo signal. The local-oscillator signal s_{RX} is a chirped signal that reproduces harmonic K of the oscillations of the first signal:

$${s}_{RX} = {e}^{j 2 π K ( {f}_{PRF 0} t + \frac{{B}_{PRF}}{2 {T}_{chirp}} {t}^{2} )} \qquad ( 12 )$$

This signal is advantageously obtained by sampling by means of a splitter 114 that samples part of the first signal inside the module 110, and by multiplying the frequency by a factor K, for example by means of a PLL 230.

By writing the echo signal as the sum of its two quadratures

$$( t - {τ}_{AR} ) = {( t - {τ}_{AR} )}_{I} + j \cdot {( t - {τ}_{AR} )}_{Q} \qquad ( 13 )$$

it is found that the signal output from the mixer 220 may be written

$${s}_{MIX} ( t ) = ( {( t - {τ}_{AR} )}_{I} + j \cdot {( t - {τ}_{AR} )}_{Q} ) \cdot conj ( {s}_{RX} ( t ) ) = {\sum }_{k = 0}^{+ ∞} \overline{{c}_{k}} \cdot {e}^{j 2 π k ( {f}_{{PRF}_{0}} ( t - {τ}_{AR} ) + \frac{{B}_{PRF}}{2 {T}_{chirp}} {( t - {τ}_{AR} )}^{2} ) - j 2 π K ( {f}_{{PRF}_{0}} t + \frac{{B}_{PRF}}{2 {T}_{chirp}} {t}^{2} )} \qquad ( 14 )$$

where “conj” designates complex conjugation. By setting α=B_{PRF}/T_{chirp} it is possible to write, in a more compact way:

$${s}_{MIX} ( t ) = {\sum }_{k = 0}^{+ ∞} \overline{{c}_{k}} \cdot {e}^{j 2 π ( - 2 \cdot k \cdot α \cdot {τ}_{A R} \cdot t - k \cdot {f}_{PRF 0} t {τ}_{AR} + k \cdot α \cdot {τ}_{AR}^{2} - ( k - K ) \cdot ( {f}_{PRF 0} t \cdot t + α {t}^{2} ) )} \qquad ( 15 )$$

It may be seen that, for k=K, a “payload” signal is obtained at intermediate frequency

$${s}_{IF} ( t ) = \cdot {e}^{j 2 π ( - 2 \cdot K \cdot a \cdot {τ}_{A R} \cdot t - {k}_{r} \cdot {f}_{PRF 0} {τ}_{A R} + {k}_{r} \cdot α \cdot {τ}_{AR}^{2} )} = \cdot {e}^{j 2 π ( - 2 \cdot K \cdot α \cdot {τ}_{A R} \cdot t )} {e}^{j φ} \qquad ( 16 )$$

where φ=2π(−kᵣ·f_{PRF0}τ_{AR}+kᵣ·α·τ_{AR}²) is a phase shift that remains constant over time. This signal s_{IF}(t) is essentially a sinusoidal signal the frequency of which is proportional to the time of flight τ_{AR}, and therefore to the distance of the target.

For any value of k other than K, there will be other contributions in the spectrum, namely spread spectra dependent on the difference K−k and raised to a frequency higher in absolute value than that of the payload signal s_{IF}(t), dependent on k and with an additional distance-dependent phase shift proportional to k. The amplitude of these other contributions will be smaller relative to the payload component s_{IF}(t) because of the fact that these signals will be spread spectrally and weighted by amplitude coefficients c̅ₖ̅ less than c̅_̅{̅k̅=̅K̅}̅.

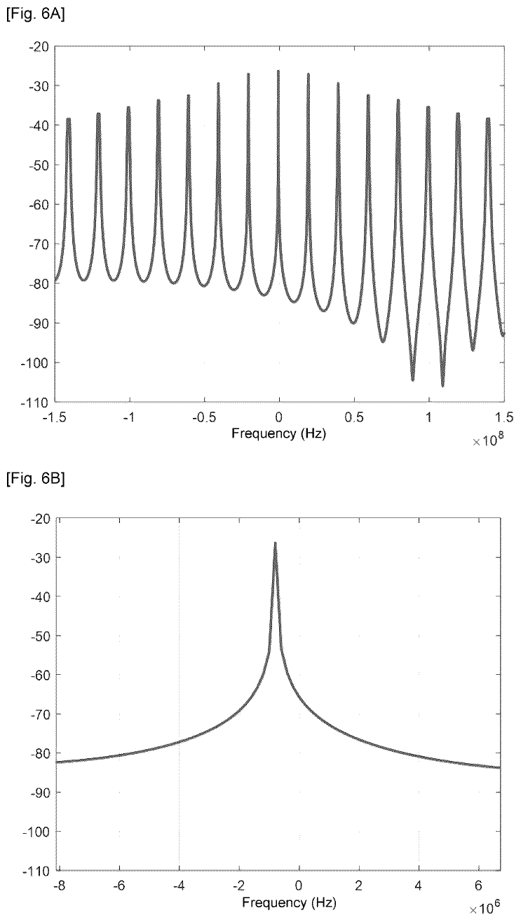

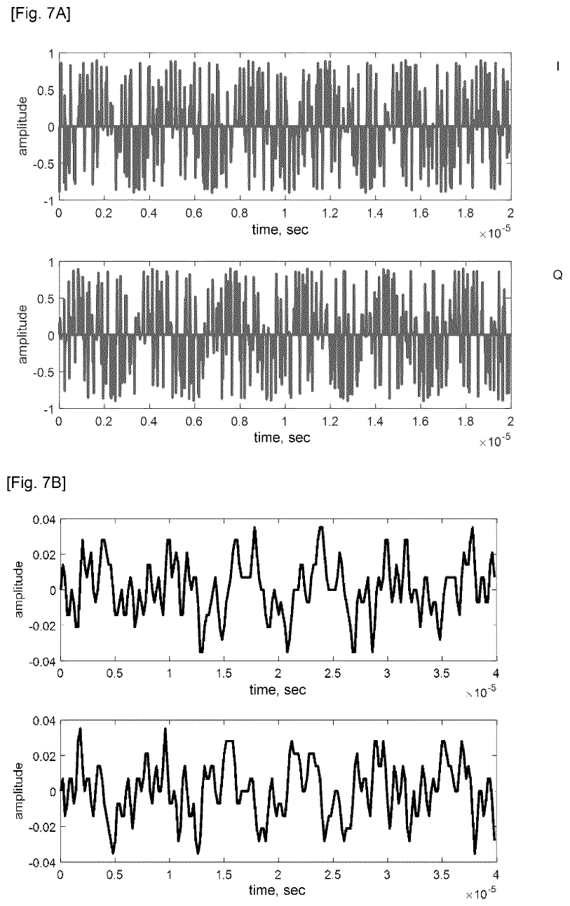

FIG. 5A shows a graph of the I component (top panel) and Q component (bottom panel) of the signal s_{MIX}(t). FIG. 5B is a detailed view obtained by dilating the time axis. FIG. 6A is the spectrum of this signal, exhibiting a central peak corresponding to the payload signal at intermediate frequency—the position of which is indicative of the distance of the target—and, at higher frequencies (multiples of f_{PRF0}), secondary peaks that are of lower amplitude and more spread spectrally, corresponding to harmonics of order other than K. FIG. 6B is a detailed view obtained by dilating the time axis, so as to show only the central peak.

A low-pass filter 250 makes it possible to filter the unwanted spectral components, then an analog-to-digital converter 260 samples and digitizes the filtered signal. Because harmonics of f_{PRF0} are filtered, which avoids the effects of spectrum aliasing, the analog-to-digital converter 260 is able to operate at a relatively low acquisition rate, of the order of f_{PRF0} (20 MSps for f_{PRF0}=20 MHZ). Advantageously, the converter 260 is able to receive a clock signal from the first signal generator 110, and more particularly from the clock 111.

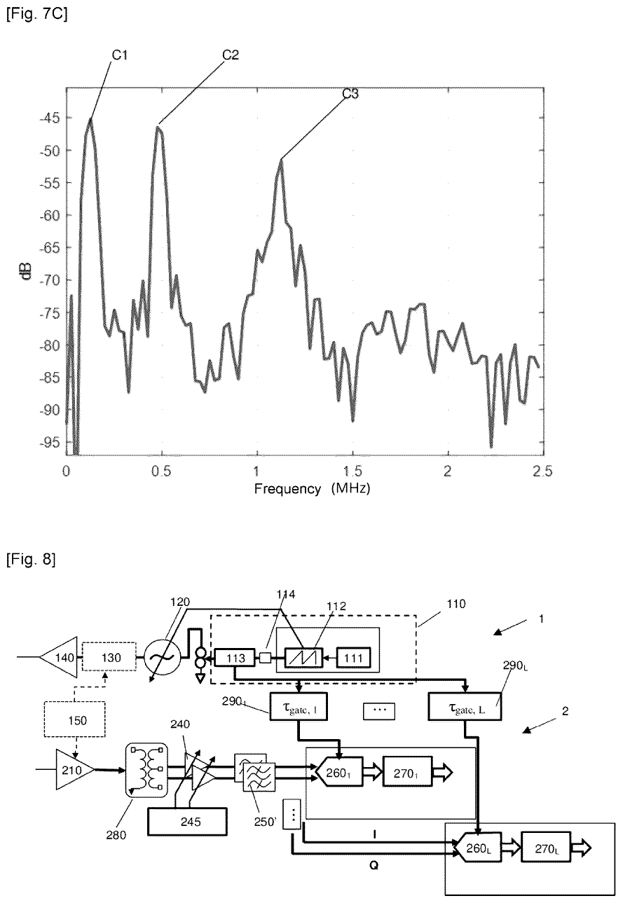

The radar device of FIG. 4 also works in the presence of a plurality of targets at different distances. For example, FIG. 7A illustrates the signal output from the mixer 220 in the case of three targets C1, C2 and C3 at distances of 1 m, 5 m and 12 m, respectively. FIG. 7B illustrates the signal output from the low-pass filter 250, and FIG. 7C its spectrum, as obtained for example at the output of a digital module 270 for computing a fast Fourier transform (FFT). In the spectrum, three peaks corresponding to the three targets may clearly be seen.

The pulsed nature of the received signal makes it possible to employ automatic gain control at the output of the mixer, this making it possible either to compensate, in an analog way, for the attenuation of the signal due to losses in free space, or to compensate for the effects of disparities in radar cross section (RCS) should the targets be present in different range boxes, or to attenuate parasitic echoes, or to achieve any combination of these various options. As illustrated in FIG. 4, the automatic gain control comprises variable-gain amplifiers 240 driven by a gain profiler 245. The latter is able to apply a predefined gain profile or indeed to determine it automatically depending on the variation as a function of time in the amplitude of the received signal. Even in the absence of automatic gain control, the temporal separation of the pulses prevents the receiver from becoming saturated and therefore improves the dynamic range of the radar. By virtue of the temporal separation of the pulses, the resolution of the converter 260 may be relatively low, and for example equal to 8 bits.

FIG. 8 shows the functional schematic of a radar device according to another embodiment of the invention comprising one transmit channel 1 and one receive channel 2. The transmit channel essentially consists of a device for generating a radar signal of the type shown in FIG. 1. The receive channel 2 differs from that of the device of FIG. 8 mainly in the absence of the mixer 220 (and therefore also of the frequency multiplier 230), in the presence of a coupler 280 for generating the I and Q components from the received and pre-amplified signal and in that the analog-to-digital converter is driven by the trigger pulses s_{PRF} generated by the generator 113 and temporally shifted by a time τ_{gate} by a delay line. As will be explained below, a given value of the delay makes it possible only to detect an echo signal corresponding to a time of flight τ_{AR}=τ_{gate}. To detect targets at unknown distances, provision may therefore be made to employ a variable delay line, for sequential acquisition, or to employ a plurality of delay lines that introduce different delays τ_{gate,1} . . . τ_{gate,l} . . . τ_{gate,L} to drive respective converters 260₁ . . . 260_{L}, each equipped with its own transform-computing module 270₁ . . . 270_{L}. It is this second solution that is shown in the figure. These converters operating in parallel have a low acquisition rate (20 MSps in the example in question, where 1 MSps=10⁶ samples per second) and a modest resolution (for example 8 bits)—they are therefore small and have a low power consumption, this allowing the number thereof to be multiplied. It is also possible to combine the approaches, using a plurality of variable delay lines in parallel.

An analog-to-digital converter clocked by a trigger pulse shifted in time by a delay τ_{gate} acquires the echo signal—filtered by the low-pass filter 250′—at times

$${t}_{acc} ( m ) = {\sum }_{n}^{nmax} {δ}_{{τ}_{G A T E} + {t}_{s} ( n ) + γ τ} \qquad ( 17 )$$

It will be noted that the low-pass filter 250′ has a cut-off frequency much higher than that of the filter 250 of the embodiment of FIG. 4, because it is applied to a radio-frequency signal.

The analog-to-digital converter has a wide analog bandwidth extending to the frequency of the microwave carrier (to 8 GHz for example) but its sampling rate is much lower (of the order of f_{PRF0}, 20 MHz for example), this largely defining its energy consumption and its feasibility.

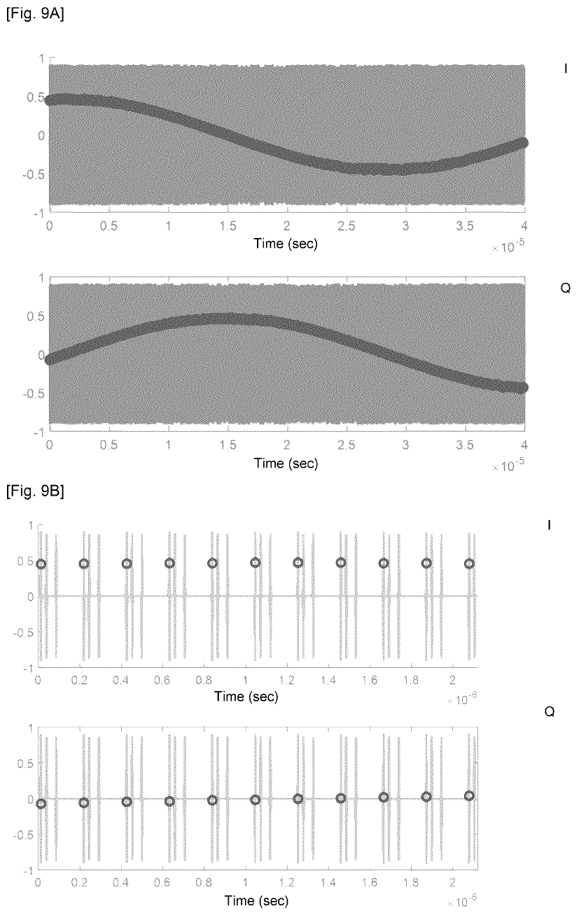

Equation (17) defines under-sampling of the microwave echo signal, allowing the component corresponding to a time of flight τ_{AR}=τ_{gate} to be extracted, as illustrated in FIG. 9A and FIG. 9B. In FIG. 9B, in particular, the groups of three echo pulses corresponding to the three targets may clearly be seen.

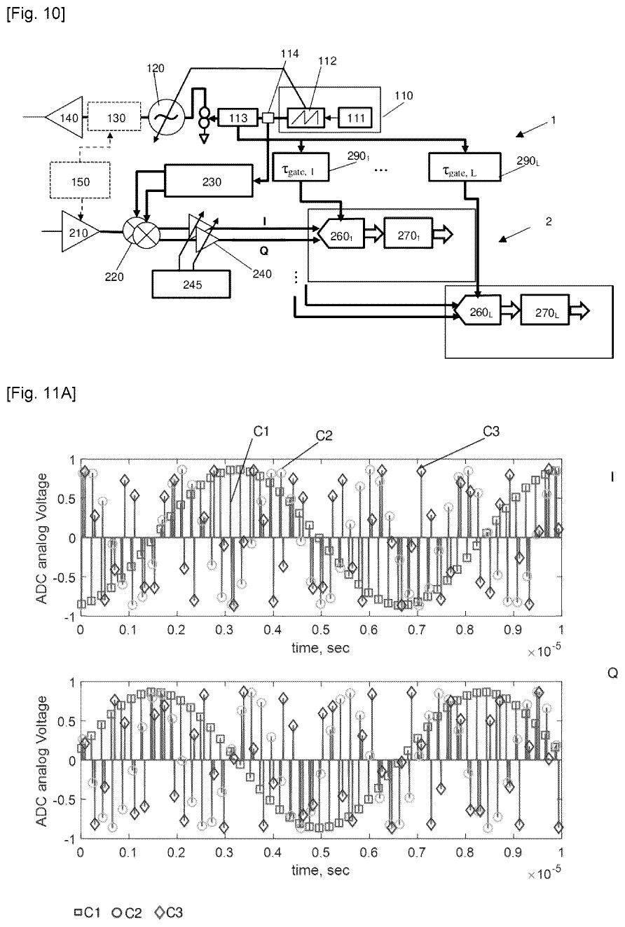

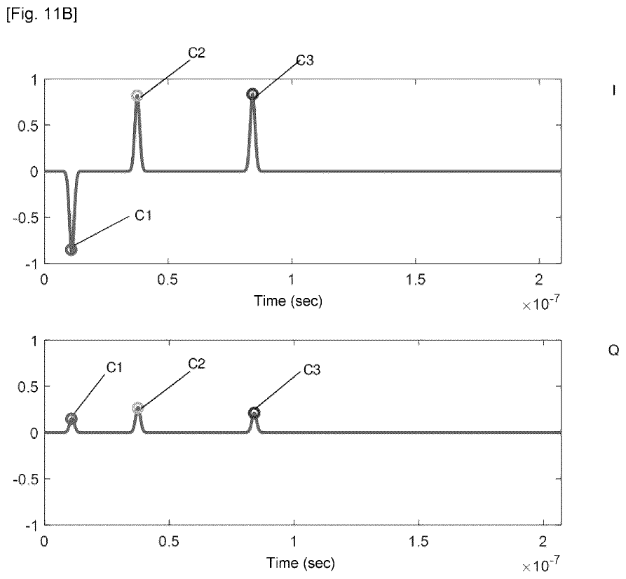

The embodiment of FIG. 10 combines frequency conversion by means of the mixer 220 and of the frequency multiplier, and direct detection by sampling by means of converters 260₁ . . . 260_{L} clocked by trigger pulses shifted by means of delay lines 290₁ . . . 290_{L}. This avoids the need to use a low-pass filter.

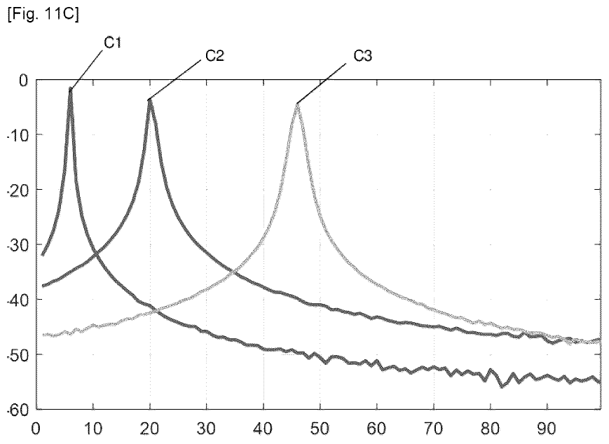

FIG. 11A and FIG. 11B illustrate sampling of the intermediate-frequency signal according to this embodiment of the invention. FIG. 11C shows the Fourier transform of signals sampled with three shifts corresponding to the times of flight of targets at 1, 5 and 12 meters.

The invention has been described with reference to particular embodiments, but variants are possible. For example, it is not essential to generate two signal components I and Q (but advantageous because it allows the acquisition rate to be decreased). Likewise, the frequency ranges indicated are given merely by way of non-limiting example.

The invention is particularly suitable for the production of “SoC” radars in which the radar device (or at least the transmit channel and/or the acquisition channel) are/is monolithically integrated, but it is not limited to this particular case.

### REFERENCES

(Antide 2020) E. Antide, M. Zarudniev, O. Michel and M. Pelissier, Comparative Study of Radar Architectures for Human Vital Signs Measurement, 2020 IEEE Radar Conference (RadarConf20), Florence, Italy, 2020, pp. 1-6, doi: 10.1109/RadarConf2043947.2020.9266569.
(Liu 209) Y.-H. Liu et al., 9.3 A680 uW Burst-Chirp UWB Radar Transceiver for Vital Signs and Occupancy Sensing up to 15 m Distance, 2019 IEEE International Solid-State Circuits Conference—(ISSCC), San Francisco, CA, USA, 2019, pp. 166-168, doi: 10.1109/ISSCC.2019.8662536.
(Andersen 2017) N. Andersen et al., A 118-mW Pulse-Based Radar SoC in 55-nm CMOS for Non-Contact Human Vital Signs Detection, in IEEE Journal of Solid-State Circuits, vol. 52, no. 12, pp. 3421-3433 December 2017, doi: 10.1109/JSSC.2017.2764051.
(Siligaris 2023) Siligaris, A., Bossuet, A., Barrau, L., Antide, E., Gonzalez-Jimenez, J. L., Dehos, C., & Zarudniev, M. (2023 September), Fast Chirping 58-64 GHZ FMCW Radar Transceiver using D-PROT Multiplier in CMOS 45 nm RFSOI for Vital Signs Detection, ESSCIRC 2023-IEEE 49th European Solid State Circuits Conference (ESSCIRC) (pp. 505-508), IEEE.

1. A device for generating a radar signal, comprising:
a generator of periodically repeated series of trigger pulses (s_{PRF}), the pulses of a given series having a linearly variable temporal spacing; and
an oscillator configured to receive as input said trigger pulses and to generate a train of periodic oscillations in correspondence with each said trigger pulse;
wherein
said oscillator has a frequency that varies as a function of a control signal (Vₜᵤₙₑ); and
the device also comprises a generator of said control signal, which is suitable for varying linearly in time the frequency of the oscillator (120) from one train of periodic oscillations to another for trains of periodic oscillations triggered by trigger pulses belonging to a given series.

2. The device as claimed in claim 1, wherein the oscillator and the generator of said control signal are configured so that the average frequency of the oscillations of said trains of periodic oscillations is a multiple, by a factor K>1, of an average repetition frequency of the trigger pulses.

3. The device as claimed in claim 2, wherein said generator of series of trigger pulses comprises a first signal generator and a trigger-pulse generator, the first signal generator being configured to generate a first signal consisting of periodic repetitions of trains of chirped oscillations, the trigger-signal generator being configured to receive as input said first signal and to generate said trigger pulses synchronously with the oscillations of said first signal.

4. The device as claimed in claim 3, wherein the oscillator and the generator of said control signal are configured so that the frequency of the train of periodic oscillations that is generated in correspondence with an n^{th} trigger pulse of a said series is given by:
$${f}_{c} ( n ) = K ( {f}_{PRF 0} \pm \frac{{B}_{PRF}}{{T}_{chirp}} {t}_{s} ( n ) )$$
where f_{PRF0} is the frequency of the oscillations of the first signal at the start of each train of chirped oscillations, B_{PRF}/T_{chirp} is the chirp rate of said oscillations and tₛ(n) is a time of generation of said nth trigger pulse, with tₛ(n=1)=0.

5. The device as claimed in claim 3, wherein said first signal generator is configured so that the chirping of the oscillations of said first signal is driven by said control signal.

6. The device as claimed in claim 2, wherein the factor K is greater than or equal to 10 and preferably between 100 and 1000.

7. The device as claimed in claim 1, further comprising a pulse shaper for modifying the temporal profile of said trains of periodic oscillations.

8. The device as claimed in claim 1, wherein said oscillator is a microwave oscillator.

9. The device as claimed in claim 1, further comprising a device for applying phase scrambling to said trains of periodic oscillations.

10. A radar device comprising:
a transmit channel comprising a device for generating a radar signal; and
a receive channel configured to receive echoes of said radar signal and to demodulate them synchronously with their generation so as to extract time-of-flight information therefrom;
wherein said device for generating a radar signal comprises:
a generator of periodically repeated series of trigger pulses (s_{PRF}), the pulses of a given series having a linearly variable temporal spacing; and
an oscillator configured to receive as input said trigger pulses and to generate a train of periodic oscillations in correspondence with each said trigger pulse;
wherein
said oscillator has a frequency that varies as a function of a control signal (Vₜᵤₙₑ); and
the device also comprises a generator of said control signal, which is suitable for varying linearly in time the frequency of the oscillator from one train of periodic oscillations to another for trains of periodic oscillations triggered by trigger pulses belonging to a given series.

11. The device as claimed in claim 10, wherein the receive channel comprises an amplifier equipped with an automatic gain control for compensating for variations in the intensity of the received echoes.

12. The device as claimed in claim 10, wherein:
the device for generating a radar signal of the transmit channel is a device wherein the oscillator and the generator of said control signal are configured so that the average frequency of the oscillations of said trains of periodic oscillations is a multiple, by a factor K>1, of an average repetition frequency of the trigger pulses, wherein said generator of series of trigger pulses comprises a first signal generator and a trigger-pulse generator, the first signal generator being configured to generate a first signal consisting of periodic repetitions of trains of chirped oscillations, the trigger-signal generator being configured to receive as input said first signal and to generate said trigger pulses synchronously with the oscillations of said first signal,
further comprising said first signal generator configured to generate said first signal consisting of periodic repetitions of trains of chirped oscillations; and
the receive channel comprises:
a frequency multiplier configured to receive as input said first signal and to multiply the frequency thereof by said factor K; and
a mixer configured to receive as input said radar echoes and to demodulate them by mixing with a signal generated by said frequency multiplier in order to obtain a demodulated signal;
a low-pass filter configured to attenuate components of said demodulated signal at frequencies that are multiples of said average repetition frequency of the trigger pulses; and
an analog-to-digital converter having an acquisition rate suitable for converting a signal at said average repetition frequency.

13. The device as claimed in claim 10, wherein:
the device for generating a radar signal of the transmit channel is a device wherein the oscillator and the generator of said control signal are configured so that the average frequency of the oscillations of said trains of periodic oscillations is a multiple, by a factor K>1, of an average repetition frequency of the trigger pulses; and
the receive channel comprises at least one analog-to-digital converter having an analog bandwidth at least equal to the spectral width of said received echoes but an acquisition rate suitable for converting a signal at said average repetition frequency of the trigger pulses, said converter being synchronized with said trigger pulses through a delay line.

14. The device as claimed in claim 10, wherein:
the device for generating a radar signal of the transmit channel is a device wherein the oscillator and the generator of said control signal are configured so that the average frequency of the oscillations of said trains of periodic oscillations is a multiple, by a factor K>1, of an average repetition frequency of the trigger pulses, wherein said generator of series of trigger pulses comprises a first signal generator and a trigger-pulse generator, the first signal generator being configured to generate a first signal consisting of periodic repetitions of trains of chirped oscillations, the trigger-signal generator being configured to receive as input said first signal and to generate said trigger pulses synchronously with the oscillations of said first signal,
further comprising said first signal generator configured to generate said first signal consisting of periodic repetitions of trains of chirped oscillations; and
the receive channel comprises:
a frequency multiplier configured to receive as input said first signal and to multiply the frequency thereof by said factor K; and
a mixer configured to receive as input said radar echoes and to demodulate them by mixing with a signal generated by said frequency multiplier in order to obtain a demodulated signal; and
at least one analog-to-digital converter having an analog bandwidth at least equal to the spectral width of said received echoes but an acquisition rate suitable for converting a signal at said average repetition frequency of the trigger pulses, said converter being synchronized with said trigger pulses through a delay line.

15. The device as claimed in claim 13, wherein said delay line has a variable delay.

16. The device as claimed in claim 13, wherein the receive channel comprises a plurality of said analog-to-digital converters synchronized with said trigger pulses through respective delay lines introducing different delays.

17. The device as claimed in claim 10, wherein the device for generating a radar signal of the transmit channel comprises a device for applying phase scrambling and the receive channel comprises a phase-descrambling device.

18. A method for generating a radar signal comprising generating periodically repeated series of trains of periodic oscillations, the trains of oscillations of a given series having a linearly variable temporal spacing; the frequency of the oscillations varying linearly from one train of periodic oscillations to another in a given series.
